(19) United States
(12) Patent Application Publication
(10) Pub. No.: US 2008/0160264 A1
(43) Pub. Date: Jul. 3, 2008

(54) RESIN DECORATION PANEL IMPREGNATED WITH SILVER NANO SOLUTION

(75) Inventor: Kee Duk Sung, Seoul (KR)

Correspondence Address: AKERMAN SENTERFITT, P.O. BOX 3188, WEST PALM BEACH, FL, 33402-3188, US

(73) Assignee: Melatone, Ltd., Incheon (KR)

(21) Appl. No.: 11/616,560

(22) Filed: Dec. 27, 2006

(51) Int. Cl. B32B 5/16

(52) U.S. Cl. 428/208

(57) ABSTRACT

In a resin decoration panel, in which a plurality of kraft sheets or color sheets are laminated together after being impregnated with phenol resin, and a pattern sheet impregnated with melamine resin is laminated and bonded on a top surface of the laminated kraft sheets or the color sheets, or in which a translucent surface protecting sheet impregnated with melamine resin is laminated on a top surface of the pattern sheet so as to not only protect the pattern sheet, on which various patterns are printed, but also increase wear resistance of the decoration panel itself, or in which a balance sheet doped with melamine resin is attached to a bottom surface of the decoration panel, one or more of the pattern sheet, the surface protecting sheet, or the balance sheet are selectively impregnated with silver nano-particles having superior offensive odor elimination effect and high anti-fungi and anti-pest effects.

### BACKGROUND OF THE INVENTION

1. Field of the Invention

The present invention relates to a resin decoration panel, in which a surface sheet such as a pattern sheet positioned on a top surface thereof is impregnated with silver nano-particles for realizing anti-fungal and anti-pest effects.

2. Discussion of Related Art

In general, resin decoration panels are attached to surfaces of furniture, such as floorboards, Medium Density Fibers (“MDFs”), Particle Boards (“PBs”) and the like, to improve appearance thereof. The resin decoration panels are laminates formed of papers, which are impregnated with melamine resin and phenol resin and then molded under high pressure at a high temperature. Such a resin decoration panel 10 includes a plurality of kraft sheets 20 or color sheets impregnated with phenol resin and laminated together, and a pattern sheet 30 impregnated with melamine resin and laminated on a top surface of the laminated kraft sheets or color sheets, wherein the laminated sheets are bonded together by thermal bonding carried out under high pressure at a high temperature, as shown in FIG. 1a.

Referring to FIG. 1b, a surface sheet 40 formed of a translucent surface protecting sheet impregnated with melamine resin is laminated on a top surface of the pattern sheet 30 so as to not only protect the pattern sheet 30 but also improve wear resistant properties of the decoration panel 10 itself, wherein the pattern sheet 30 is printed with various patterns thereon.

Furthermore, a balance sheet 50 is further attached to a bottom surface of the decoration panel 10 of FIG. 1a or FIG. 1b.

In the conventional decoration panel, the pattern sheet and the surface sheet are used as being impregnated with melamine resin, so that surfaces thereof are superior in properties such as fouling resistance, wear resistance, waterproofing resistance and chemical resistance and widely used as interior decoration materials or surface materials of furniture.

The above decoration panel has, however, a disadvantage that the decoration panel is lacking in anti-fungal and anti-pest effects.

### SUMMARY OF THE INVENTION

Therefore, the present invention is derived to resolve the above and any other disadvantages of the prior art.

According to the present invention, there is an object to provide a resin decoration panel to be widely used as a surface material for furniture or interior decoration materials, in which a pattern sheet or a surface sheet has anti-fungal and anti-pest effects.

In order to achieve the above objects, according to the present invention, there is provided a resin decoration panel including a plurality of kraft sheets or color sheets impregnated with phenol resin and laminated together, and a pattern sheet and a surface sheet impregnated with melamine resin and laminated on a top surface of the kraft sheets or the color sheets, all the above sheets being integrated into a single body by thermal bonding carried under high pressure at a high temperature, characterized in that the surface sheet and the balance sheet are impregnated with a mixture solution consisting of a melamine resin solution and a silver nano solution exhibiting anti-fungal and anti-pest effects.

The mixture solution consists of 0.2˜0.5 wt % of the silver nano solution exhibiting anti-fungal and anti-pest effects with respect to 99.50˜99.80 wt % of the melamine resin solution.

### BRIEF DESCRIPTION OF THE DRAWINGS

The objects, features and advantages of the present invention will be more clearly understood from the following detailed description in conjunction with the accompanying drawings, in which

FIG. 1 shows structures of general decoration panels, in which

FIG. 1a is a cross-sectional view showing a general decoration panel employing kraft sheets and a pattern sheet;

FIG. 1b is a cross-sectional view showing a general decoration panel employing kraft sheets, a pattern sheet and a surface sheet; and

FIG. 1c is a cross-sectional view showing a general decoration panel employing kraft sheets, a pattern sheet, a surface sheet, and a balance sheet; and

FIG. 2 shows decoration panels according to preferred embodiments of the present invention, in which

FIG. 2a is a cross-sectional view showing a resin decoration panel having silver nano-particles in a pattern sheet according to a preferred embodiment of the present invention;

FIG. 2b is a cross-sectional view showing a resin decoration panel having a surface sheet containing silver nano-particles according to another preferred embodiment of the present invention; and

FIG. 2c is a cross-sectional view showing a resin decoration panel having a balance sheet containing silver nano-particles according to still another preferred embodiment of the present invention.

### DETAILED DESCRIPTION OF THE PREFERRED EMBODIMENTS

Now the preferred embodiments according to the present invention will be described with reference to the accompanying drawings.

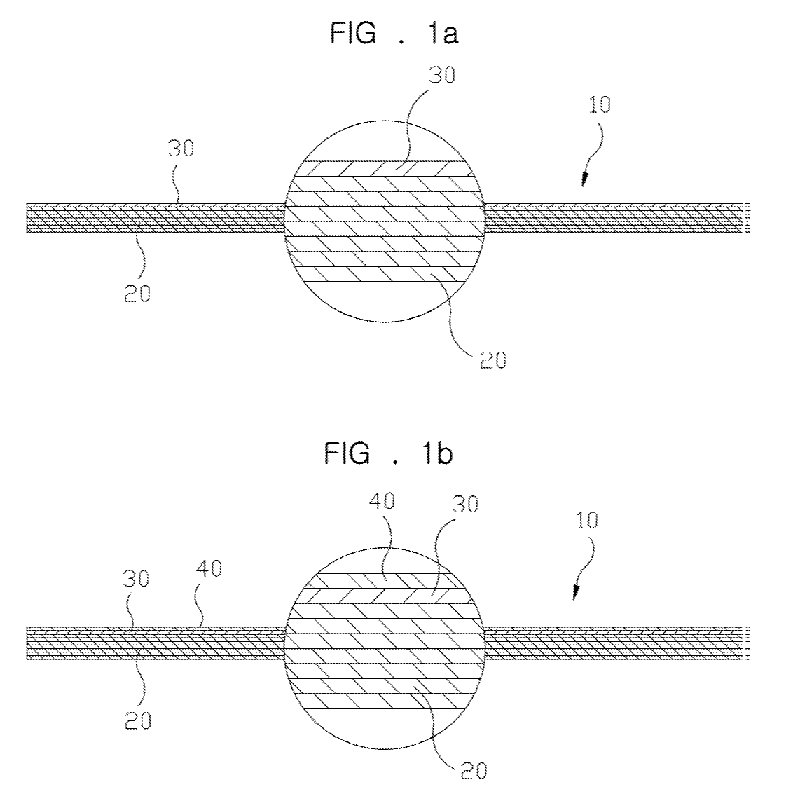

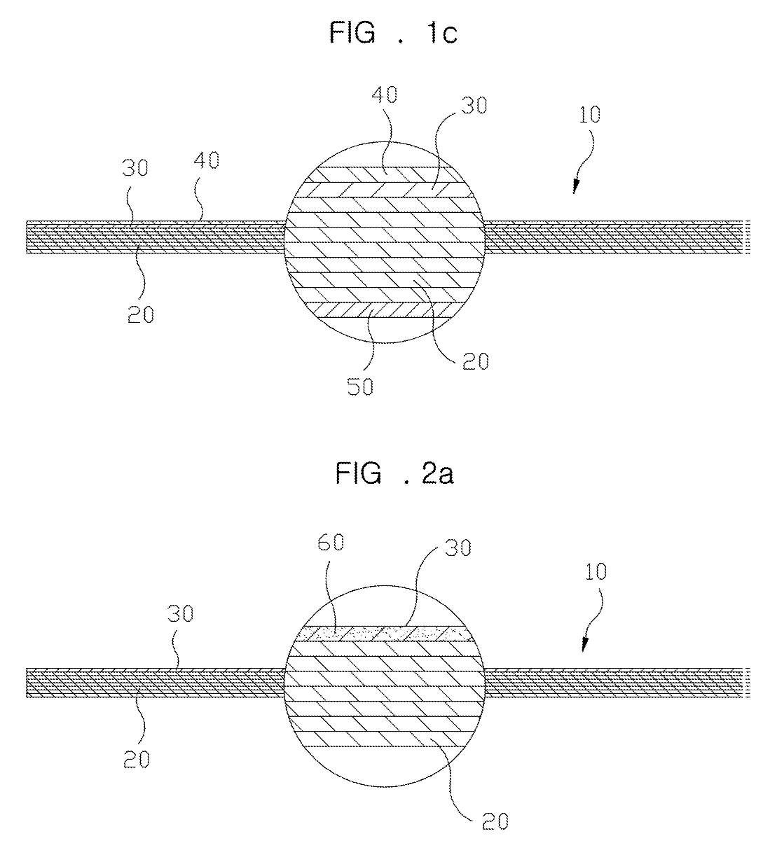

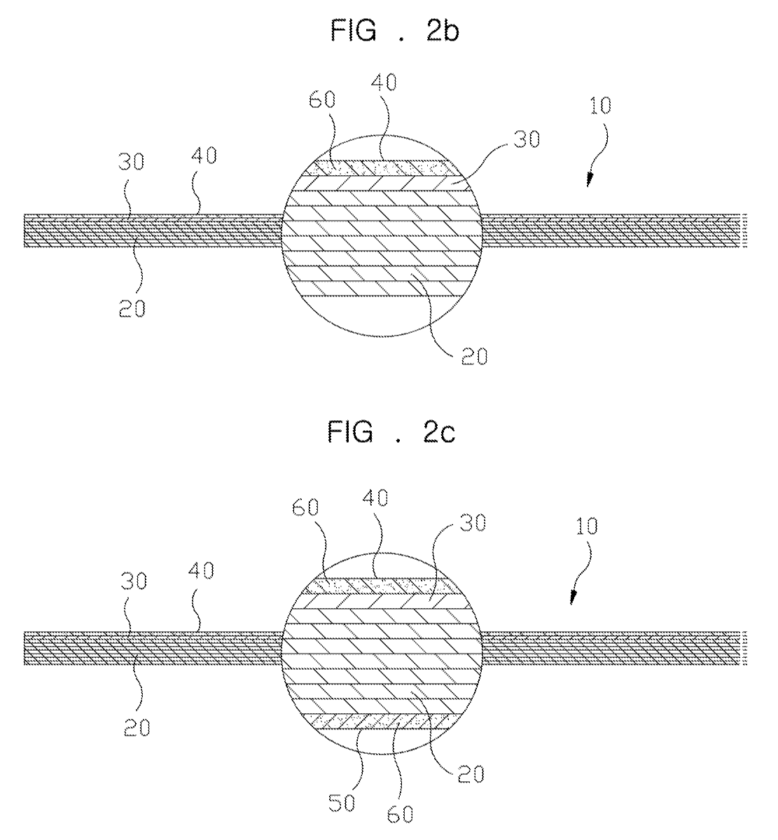

FIG. 2 shows structures of resin decoration panels according to preferred embodiments of the present invention. In a prior art decoration panel 10, in which a plurality of kraft sheets 20 or color sheets are laminated together after being impregnated with phenol resin, and a pattern sheet 30 impregnated with melamine resin is laminated and bonded on a top surface of the laminated kraft sheets 20 or the color sheets, or in which a translucent surface protecting sheet 40 impregnated with melamine resin is laminated on a top surface of the pattern sheet 30, so as to not only protect the pattern sheet 30, on which various patterns are printed, but also increase wear resistance of the decoration panel 10 itself, or in which a balance sheet 50 doped with melamine resin is attached to a bottom surface of the decoration panel 10 as shown in FIG. 1a or FIG. 1b, referring to FIG. 2a-FIG. 2c, at least any one or more of the pattern sheet 30, the surface protecting sheet 40, or the balance sheet 50 are selectively impregnated with silver nano-particles 60.

The silver nano-particles 60 are sprayed or doped on the above sheets by using brushes or rollers. The silver nano-particles 60 may be preferably mixed into the melamine resin, with which the above sheets are impregnated, so that the above sheets are impregnated with the silver nano-particles together with the melamine resin.

Anti-fungal and anti-pest effects of the resin decoration panel of the present invention may be modified according to a content of the silver nano-particles, wherein the silver nano-particles are preferably contained in the melamine resin by 0.2-0.5%. Of course, the content of the silver nano-particles may be changed in the scope of the present invention, which is not regarded as departing from the spirit of the present invention.

According to the present invention as described hereinabove, there may be some differences in the anti-fungi and anti-pest effects depending on what sheet contains the silver nano-particles 60. If the silver nano-particles 60 are contained in the surface sheet or the pattern sheet, the surface sheet or the pattern sheet further exhibits effects of sterilization and offensive odor treatment by anions emitted from the surface sheet or the pattern sheet itself, promoting health of users.

The silver nano-particles 60 also prevent food from rotting and promoting health of the users.

As described hereinabove, according to the present invention, a silver nano solution is mixed into a melamine resin solution, with which a pattern sheet, a surface sheet or a balance sheet is impregnated for improving wear resistance, waterproofness and chemical resistance, so that the pattern sheet, the surface sheet or the balance sheet is impregnated with the silver nano solution having offensive odor elimination effect as well as the high anti-fungi and anti-pest effects, simultaneously with the melamine resin solution. Therefore, the resin decoration panel of the present invention is provided to users with the anti-fungi and anti-pest effects in addition to the wear resistant and chemical resistant properties.

Although the foregoing description has been made with reference to the preferred embodiments, it is to be understood that changes and modifications of the present invention may be made by the ordinary skilled in the art without departing from the spirit and scope of the present invention and appended claims.

What is claimed is:

1. A resin decoration panel, comprising:
a plurality of kraft sheets or color sheets impregnated with phenol resin and laminated together,
a pattern sheet and a surface sheet impregnated with melamine resin and laminated on a top surface of the kraft sheet or the color sheets,
a balance sheet positioned at a bottom surface of the kraft sheet or the color sheets,
wherein all the sheets are integrated into a single body by thermal bonding carried out under high pressure at a high temperature, and
wherein one or more of the pattern sheet, the surface sheet or the balance sheet are impregnated with silver nano-particles.

2. The resin decoration panel as claimed in claim 1, wherein the silver nano-particles is mixed with a melamine resin solution by 0.2˜0.5%.

3. The resin decoration panel as claimed in claim 1, wherein the resin decoration panel comprises no balance sheet.

4. The resin decoration panel as claimed in claim 1, wherein the resin decoration panel comprises no surface sheet.

5. The resin decoration panel as claimed in claim 1, wherein the resin decoration panel comprises no surface sheet and no balance sheet.
